(19) United States
(12) Patent Application Publication
(10) Pub. No.: US 2026/0346892 A1
(43) Pub. Date: Nov. 5, 2026

(54) TROLLEY

(71) Applicants: Claudio ZONZINI, Casaleone (VR) (IT); Jacopo ZONZINI, Casaleone (VR) (IT); Arianna ZONZINI, Cerea (VR) (IT); Laura ZONZINI, Cerea (VR) (IT)

(72) Inventors: Claudio ZONZINI, Casaleone (VR) (IT); Jacopo ZONZINI, Casaleone (VR) (IT); Arianna ZONZINI, Cerea (VR) (IT); Laura ZONZINI, Cerea (VR) (IT)

(21) Appl. No.: 19/487,510

(22) PCT Filed: Jun. 6, 2024
(86) PCT No.: PCT/IB2024/055555

§ 371 Date: Nov. 25, 2025

(30) Foreign Application Priority Data
Jun. 8, 2023 (IT) 102023000011784

(51) Int. Cl. B62B 3/06; B62B 5/00; B62B 5/02

(52) U.S. Cl. CPC B62B 3/0612; B62B 5/0036; B62B 5/02; B62B 2203/24; B62B 2301/256

(57) ABSTRACT

Trolley for lifting and transporting a pallet includes a support structure for two first and second tracks. The first and second two tracks are parallel to and spaced apart from each other. The second tracks are positioned at the front or rear of the trolley and are arranged externally with respect to the first tracks. The trolley also includes motor means to move the first and second tracks and a structure articulated to the support structure, which is configured to support and move a pallet. The structure includes two pallet-holder arms configured to engage a pallet. The trolley also includes a first actuator, mounted on the structure to support and move at least one pallet and is configured to move the pallet-holder arms away from/towards the first tracks, and at least one second actuator operatively configured to rotate the pallet-holder arms towards the front or the rear of the trolley.

### CROSS-REFERENCE TO RELATED APPLICATIONS

This application is a § 371 National Phase of PCT/IB2024/055555, filed Jun. 6, 2024, which claims priority to Italian Patent Application 102023000011784, filed Jun. 8, 2023, the entire contents of all of which are incorporated by reference herein as if fully set forth.

### TECHNICAL FIELD

The present invention concerns a trolley for lifting and transporting a pallet, with or without a load, in particular on stairs, both straight and helical, or other inclined paths (ramps), as well as on substantially flat paths. Preferably, the present invention concerns an electric pallet truck suitable for the transport, even on stairs and/or ramps, of at least one pallet, on which at least one load is placed or could be empty, or even for the transport of a stack of pallets.

### STATE OF THE ART

Both manual and motorized pallet trucks are known and particularly used.

In particular, the pallet truck is a trolley specifically used for the handling and transport of pallets loaded with goods of various types, shapes and weights. This type of trolley can move by electric or servo-assisted manual traction and is equipped with a lifting system that allows the pallet to be detached from the ground, with the load positioned on it, in order to allow it to be moved.

Pallets have standard and well-defined dimensions and, therefore, the pallet truck is also generally a standard trolley with well-defined dimensions that vary little between one manufacturer and another.

More in detail, a pallet truck is generally equipped with a lifting structure which is mobile along a central upright and which is shaped like a fork with two prongs which fit inside the slots provided in the pallet in order to lift it and thus be able to handle and move it.

Currently, pallet trucks are mainly used for transporting pallets along flat surfaces and, therefore, are generally equipped with wheels.

Manual pallet trucks are used in cases where only basic handling is required which does not require large amounts of force during transport. In a manual pallet truck, lifting and/or moving is manual and, in particular, moving occurs by pulling or pushing the trolley towards the desired direction.

Instead, in the electric pallet truck both the lifting of the pallet from the ground and the movement of the trolley take place using special electric actuators mounted on board the pallet truck itself.

The known electric pallet trucks are not fully satisfactory for easily and safely transporting pallets, with or without a load, on stairs or ramps.

### OBJECTS

An object of the present invention is to propose a trolley for lifting and transporting a pallet which allows to overcome, at least in part, the drawbacks present in known trolleys.

Another object of the present invention is to propose a trolley that is capable of transporting a pallet on stairs or ramps.

Another object of the present invention is to propose a trolley that allows you to safely transport a pallet with or without a load on stairs or ramps, so as not to ruin or overturn the load.

Another object of the present invention is to propose a trolley by which the transport conditions can be easily adjusted during the ascent and descent on and from a staircase/ramp.

Another object of the present invention is to propose a trolley capable of transporting a load both on straight stairs and on helical stairs even with a very low radius of curvature.

Another object of the present invention is to propose a trolley that can be driven from both its sides.

Another object of the present invention is to propose a trolley capable of balancing the load during transport on stairs.

Another object of the present invention is to propose a trolley that allows large loads, in particular high loads, to be transported in a stable, safe and comfortable manner.

Another object of the present invention is to propose a trolley that is reliable and resistant over time.

Another object of the present invention is to propose a trolley that can be manufactured simply, quickly and at low cost.

Another object of the present invention is to propose a trolley of low weight and easy to transport.

Another object of the present invention is to propose a trolley which is an alternative and/or improvement compared to traditional solutions.

Another object of the present invention is to propose a trolley that has an alternative and/or improved configuration, both in constructive and functional terms, compared to traditional solutions.

### SUMMARY

All these objects, both individually and in any combination thereof, and others that will result from the following description are achieved, according to the invention, with a trolley for lifting and transporting a pallet having the characteristics indicated here below.

In particular, the present invention concerns a trolley for lifting and transporting at least one pallet on a staircase and/or ramp, said trolley being of the tracked pallet truck type, characterized by the fact of comprising:
a support structure which is configured to support two first tracks and two second tracks,
said first two tracks, which are parallel and spaced apart from each other,
said two second tracks which are parallel and spaced apart from each other, said second tracks being positioned at the front F or the rear R of the trolley, being inclined with respect to the first tracks and being arranged externally with respect to said first tracks,
motor means, preferably of the electric type, for moving the two first tracks and the two second tracks,
a structure which is articulated to the support structure and which is configured to support and move at least one pallet, said loading structure comprising two pallet-holder arms which are configured to engage/fork a pallet to be transported and/or lifted,
at least a first actuator which is mounted on said support and movement structure of at least one pallet and which is configured to move the pallet-holder arms so as to distance/bring them closer from/to the first tracks,
at least a second actuator which is operatively associated with said support structure and with said support and movement structure of at least one pallet and which is configured to rotate the pallet-holder arms (43) towards the front F of the trolley and also, in a distinct moment, towards the rear R of the trolley, and in which the support and movement structure of at least one pallet is articulated to the support structure above the first tracks.

Preferably, the support and handling structure of at least one pallet comprises a first frame which is articulated to the support structure.

Preferably, the support and movement structure of at least one pallet includes a second frame which is mounted on said first frame so that said first actuator causes the movement/sliding of said second frame with respect to said first frame.

Preferably, the support and handling structure of at least one pallet includes two pallet-holder arms which are mounted on the second frame.

Preferably, the trolley is configured so that, when the pallet-holder arms are in the position suitable for forking a pallet resting on the ground/soil, the pallet-holder arms and also the first tracks that rest on the ground are located below the upper surface of the pallet and also within the overall dimensions of the pallet itself.

Preferably, the motor means comprise a first electric motor to implement the movement of a first track and a second track positioned on a first side of the trolley, and a second electric motor to implement the movement of the other first track and of the other second track positioned on the other side of the trolley.

Preferably, said at least one first actuator is of the electric type. Preferably, said at least one second actuator is of the electric type.

Preferably, the trolley comprises first motion transmission means which are configured to transfer the output motion of said motor means in order to cause the movement of the respective second tracks,

Preferably, the second tracks also act as a motion transmission member in order to cause the movement of the respective first tracks.

Preferably, the support structure comprises two elongated sections for supporting rotatable elements around which the two first tracks are wrapped respectively. Preferably, the support structure includes a frame for supporting further rotatable elements around which the two second tracks are wrapped respectively, said frame being inclined with respect to said two elongated sections. Preferably, the support structure includes a portion raised with respect to the first tracks at which the support and movement structure of at least one pallet is articulated.

Preferably, at least a second actuator has one end articulated to the first frame while the other end is articulated to said frame which is inclined.

Preferably, the two electric motors are mounted on said support frame of the second tracks.

Preferably, at least a second actuator is articulated to said frame supporting the second tracks at an area of said frame which is interposed between said two electric motors.

Preferably, the raised portion is defined at the connection area between the first tracks and the second tracks.

Preferably, the support and movement structure of at least one pallet is articulated to the support structure at said raised portion of said support structure.

Preferably, the two pallet-holder arms are configured so as to overlap vertically respectively with the two first tracks, preferably so that, in plan view, the two first tracks are covered by the respective two pallet-holder arms.

Preferably, the upper base of the two pallet-holder arms is always arranged above the upper section of the first tracks.

Preferably, the first actuator is completely housed within the space required for the support and movement structure of at least one pallet.

Preferably, the pallet support and handling structure is configured to fork a pallet, to move the forked pallet so as to distance/bring it closer from the first tracks, and also to rotate the forked pallet towards the front of the trolley and also, in a distinct moment, towards the back of the cart.

Preferably, the pallet support and movement structure are articulated to the support structure at the connection area between the first tracks and the second tracks.

Preferably, the first actuator is completely housed within the size of the support and movement structure of at least one pallet.

Preferably, said at least one second actuator is positioned rearward with respect to the structure, articulating with one of its ends to an inclined support frame of the second tracks.

Preferably, each of the two pallet-holder arms is extendable, to thus assume at least an elongated condition and a shortened condition, and preferably also one or more intermediate conditions.

Preferably, said at least one first actuator is of the linear type, and at least one second actuator is of the linear type.

Preferably, the trolley comprises two second actuators, each of which is positioned at one side of the pallet support and movement structure.

Preferably, the first actuator is mounted on the first frame and is connected to the second frame by means of a return mechanism, more preferably a pulley.

Preferably, the two first tracks are placed side by side along a direction parallel to a Y direction and develop longitudinally parallel to an X direction corresponding to the direction of advancement of the trolley. When the first frame is arranged substantially perpendicular to the first tracks, at least one first actuator causes a lifting/lowering movement of the pallet-holder arms along a direction parallel to a Z direction, which is perpendicular to the X and Y directions, and in such a way that the pallet-holder arms are arranged parallel to the first tracks for their entire longitudinal development.

Preferably, the first actuator is arranged centrally between the two first tracks.

Preferably, when the two pallet-holder arms are in the closest position with respect to the two first tracks, the height of said two arms with respect to the ground is less than 100 mm, more preferably less than 60-80 mm.

### BRIEF DESCRIPTION OF THE DRAWINGS

The present invention is further clarified below in some of its preferred practical embodiments reported for purely illustrative and non-limiting purposes with reference to the attached drawings, in which:

FIG. 1 shows a perspective view of the trolley according to the invention in a first condition in which the second frame is in a lowered position (usable, for example, to fork a pallet with the arms),

FIG. 2 shows the trolley according to the invention in the same view as in FIG. 1 in a different condition in which the second frame is in a raised condition,

FIG. 3 shows the trolley according to the invention according to a plan view,

FIG. 4a shows a front view of the trolley in the condition shown in FIG. 1,

FIG. 4b shows a side view of the trolley in the condition shown in FIG. 1,

FIG. 5a shows a front view of the trolley in the condition shown in FIG. 2,

FIG. 5b shows a side view of the trolley in the condition shown in FIG. 2,

FIG. 6 shows a side view of the trolley according to the invention with the second frame in a lowered position and with the first frame rotated towards the rear R of the trolley,

FIG. 7 shows a side view of the trolley according to the invention with the second frame in the raised position and with the first frame rotated towards the front F of the trolley,

FIG. 8a shows a side view of the trolley according to the invention while climbing a ladder, with a pallet on/engaged by the arms and with the second frame in a lowered position,

FIG. 8b shows the same view as FIG. 8a in a condition where the second frame is in a raised position,

FIG. 9 shows a side view of the trolley according to the invention while climbing a staircase, always with a pallet engaged by the arms, and with a different/opposite direction of advancement on the staircase compared to that of FIGS. 8a and 8b,

FIG. 10a shows a side view of the trolley according to the invention while climbing a ramp without steps, with a pallet on/engaged by the arms and with the second frame in a lowered position,

FIG. 10b shows the same view as FIG. 10a in a condition where the second frame is in a raised position,

FIG. 11 shows a side view of the trolley according to the invention while climbing a ramp without steps, always with a pallet engaged by the arms, and with a different/opposite direction of advancement on the staircase compared to that of FIGS. 10a and 10b,

FIG. 12a shows a perspective view of the support structure of the tracks of the trolley according to the invention with some components removed to better appreciate some details,

FIG. 12b shows an enlarged detail of FIG. 12a,

FIG. 13a shows a side view of the loading structure in a condition in which the pallet-holder arms are extended,

FIG. 13b shows a side view of the loading structure in a different condition in which the pallet-holder arms are retracted,

FIG. 14a shows a perspective view of the trolley according to the invention in a different embodiment,

FIG. 14b shows a perspective view of the trolley in FIG. 14a in a different condition in which the second frame is in a raised condition,

FIG. 15 shows the trolley of FIG. 14a in a different perspective, and

FIG. 16 shows a front view of the trolley in FIG. 14a,

FIG. 17 shows a perspective view of a variant of the trolley according to the invention during its self-loading onto a van,

FIG. 18 shows a side view of FIG. 17.

### DETAILED DESCRIPTION OF THE PREFERRED EMBODIMENTS

In the figures of the attached drawing tables, the same or similar parts or components are marked with the same reference numbers.

Conveniently, the trolley according to the invention, indicated overall with the reference number 1, is specifically configured, suitable and intended for lifting and transporting at least one pallet 50 on stairs 90 and/or ramps 91 without steps, as well as on flat and substantially horizontal terrains.

The trolley 1 is a trolley of the tracked pallet truck type, preferably with an entirely and only electric drive. In particular, the trolley 1 is capable of forking and lifting a pallet 50, as well as tilting and moving/handling the pallet thus forked and lifted.

Conveniently, by “pallet” 50 it is meant a transport platform on which a load to be transported and lifted is usually positioned and which has at the side, corresponding to its thickness in height, at least one slit for the introduction of two or more picking/forking arms (i.e. lifting fork tines) of the trolley.

Conveniently, the pallet 50 to be lifted and transported can be made of wood but can also be made of other materials (for example metal or plastic). Conveniently, the pallet 50 to be lifted and transported is of the traditional type.

Conveniently, the pallet 50 to be lifted and transported can have standardized dimensions according to the “ISO” standard, according to the European “EUR” standard (800 mm×1200 mm, 1200 mm×1200 mm, etc.) or according to the American standard (40 inches×48 inches, 48 inches×48 inches, etc.).

Conveniently, a load can be positioned on the pallet 50 lifted and transported by the trolley 1 or it can also be without load, where “load” means any object or goods (or even a set of several objects/goods), whether packaged or not packaged, which is placed on the pallet in order to carry out its transport and/or lifting.

Conveniently, the trolley 1 according to the invention can also be used to lift and transport a stack of pallets.

As is clear from the figures, the trolley 1 is suitable for transporting a pallet 50 over a difference in height, in particular on a staircase 90 with steps, both up and down, or on a ramp 91 without steps, both up and down. Conveniently, the trolley 1 is also suitable for transporting a pallet 50 along a substantially flat path.

The trolley 1 includes a support structure 2 with two first tracks 3 and two second tracks 4.

Conveniently, the two first tracks 3 are equal to each other, while the two second tracks 4 are equal to each other. Conveniently, the first tracks 3 have a much greater length than that of the second tracks 4.

Suitably, the support structure 2 is configured to support the two first tracks 3 and the two second tracks 4.

Conveniently, the first tracks 3 are movably and rotatably mounted on the support structure 2 so as to protrude downwardly from the latter and thus define the main sliding plane 19 of the trolley 1 at the bottom. Conveniently, the first tracks 3 comprise and/or define at the bottom the main support sections of the trolley 1 during its movement, in particular on the floor but—preferably—also on a staircase or ramp.

Preferably, the support structure 2 comprises two elongated sections 20, each of which supports a first pair of rotatable elements (for example pulleys, cogwheels or other equivalent rotatable elements) around which a corresponding first track 3 is wrapped; in particular, a first rotatable element 21′ is provided at a first end of each elongated section 20, while at the other end of each elongated section 20 (which is preferably defined at the front F of the trolley 1) a second rotatable element 21″ is provided.

Conveniently, the first tracks 3 develop along (or parallel to) a direction X corresponding to the direction of advancement of the trolley 1. Conveniently, the X direction can also correspond to the direction of development in length of the trolley 1.

The second tracks 4 are inclined with respect to the first tracks 3 and, in particular, they are inclined with respect to the main sliding plane 19. In particular, the second tracks 4 develop along (or parallel to) a direction X′ which is inclined with respect to the X direction of development of the first tracks 3.

The second tracks 4 can be positioned at the front For the rear R of the trolley 1, where the front F and the rear R define two areas opposite to each other along the direction X. Conveniently, the front F of the trolley identifies the most front (or upstream) area of the trolley according to a direction of advancement of the trolley, while by rear R of the trolley it is meant the most rear (or downstream) area of the trolley according to said direction of advancement of the trolley.

In a possible embodiment such as the one illustrated in the figures, the second tracks 4 are positioned at the rear R of the trolley 1; however, it is understood that in a possible embodiment (not illustrated in the figures) the second tracks could be positioned at the front F of the trolley.

The first tracks 3 are parallel and placed side by side to each other along a direction parallel to a direction Y which is perpendicular to the direction X which substantially corresponds to the direction of width development of the trolley 1.

Conveniently, the Z direction—which is perpendicular to both the X and Y directions so as to complete the Cartesian triple—can correspond to the direction of height development of trolley 1.

The second tracks 4 are parallel and placed side by side to each other along the Y direction or in any case along a direction parallel to Y.

The second tracks 4 are arranged laterally and externally with respect to the first tracks 3. In other words, the first tracks 3 are placed side by side and are arranged internally between the second tracks 4 along the Y direction or in any case along a direction parallel to the Y axis.

Preferably, the second tracks 4 are not rotary and rotatable with respect to the first tracks 3; in particular, the arrangement and orientation of the second tracks 4 with respect to the first tracks 3 is fixed.

Conveniently, the movement of the trolley 1 on a substantially horizontal flat surface occurs only or in any case mainly by means of the first tracks 3. Preferably, when moving the trolley 1 on a substantially horizontal flat surface, only the lower section of the second tracks 4 can be in contact with the ground/soil. Preferably, the lowermost section of the second tracks 4 can be, at least in part, coplanar or tangential to the first sliding plane 19.

Preferably, the support structure 2 can comprise a support frame 22, which is inclined, for the two second tracks 4. In particular, said two second tracks 4 are movably and rotatably mounted on the outermost opposite sides/flanks of said support frame 22. Preferably, the support frame 22 protrudes laterally and externally with respect to the elongated sections 20 and is arranged inclined with respect to said elongated sections.

Preferably, two pairs of further rotatable elements are also provided (for example pulleys, cogwheels or other equivalent rotatable elements), each of which is mounted at a respective external side/flank of the support frame 22 and, in particular, comprises a third rotatable element 23′ and a fourth rotatable element 23″; each second track 4 is wrapped around a corresponding pair of further rotatable elements 23′ and 23″.

Conveniently, as mentioned, each track 3 and 4 is wrapped around respective rotatable elements (cogwheels, pulleys or chains), which are rotating around respective rotation axes coinciding or parallel to the Y direction, so that each track 3 and 4 has a first section, in use, which is upper, preferably substantially flat, a second section, in use, which is lower, preferably substantially flat, and intended to come into contact with the support surface (ground/soil and/or stairs and/or ramp).

Conveniently, in a possible embodiment, the two pairs of rotatable elements 21′ and 21″ can be coplanar with each other in an X-Y plane and can be aligned two by two along respective axes A′ and A″, both parallel to the Y direction.

Conveniently, in a possible embodiment such as the one illustrated in the figures, the two third rotatable elements 23′ are coaxial (and in particular share the axis A′) and are integral in rotation with the respective first rotatable elements 21′; in particular, each third rotatable element 23′ and a corresponding first rotatable element 21′ are coupled onto the same shaft 29 aligned parallel to the Y direction; furthermore, each third rotatable element 23′ is mounted on the same shaft 29 as the first rotatable element 21′ externally with respect to the latter. Conveniently, in a possible embodiment not illustrated in the figures, each third rotatable element 23′ can be made in a single body with a corresponding first rotatable element 21′.

The fourth rotatable elements 23″ are aligned to each other along an axis A′″ which is parallel to the Y direction, which protrudes externally (from the side opposite to the A″ axis along the X direction) beyond the A′ axis and which is raised along the Z direction (in particular it is at a different height/distance compared to that of the A′ and A″ axes).

The trolley 1 also includes motor means, preferably of the electric type, for moving the two first tracks 3 and the two second tracks 4. Preferably, the motor means for moving the tracks include two electric motors, respectively a first motor 25′ and a second motor 25″, each of which is dedicated to driving a corresponding tracked assembly consisting of a first track 3 and a second track 4 positioned on the same side of the trolley. In essence, a first track 3 and a second track 4 provided at one side of the trolley 1 are driven by a first corresponding electric motor 25′, while the other first track 3 and the other second track 4 provided at the other side of the trolley 1 are driven by a second corresponding electric motor 25″. Advantageously, in other words, the first track 3 and the second track 4 provided on the same side of the trolley 1 are driven by the first motor 25′ independently from the other first track 3 and the other second track 4 which are instead driven from the second motor 25″.

Conveniently, the two motors 25′ and 25″ can be mounted on the support frame 22 and, preferably, are facing each other. In particular, the rotating output shafts of the two motors 25′ and 25″ are facing each other and aligned along an axis A″″ which is parallel to the Y direction and, in particular, is parallel to the rotation axes A′, A″ and A′″ of the rotatable elements 21′, 21″ and of the further rotatable elements 23′ and 23″.

Preferably, the two motors 25′ and 25″ are configured to cause through first transmission means 26 or, possibly (in a possible embodiment not shown here), also directly—the movement of the corresponding second tracks 4 and furthermore, through the movement of the second tracks 4, the motion is transferred to the respective first tracks 3.

Preferably, the trolley 1 comprises first motion transmission means 26 which are configured to transfer the output motion of said motor means, preferably of the electric type 25′ and 25″, in order to cause the movement of the respective second tracks 4. In particular, the first transmission means 26 can comprise a transmission belt 26″ which is wrapped around a fifth rotatable element 26′, mounted on the rotating output shaft of the engine 25′ or 25″, and around a sixth rotatable element 26′′ which is coaxial and integral in rotation with a corresponding fourth rotatable element 23″.

Preferably, in the trolley 1 each second track 4 also acts as a motion transmission member for the corresponding first track 3 which is placed on the same side of said second track 4. In particular, the movement of the second track 4, which is caused by the rotational activation of the fourth rotatable element 23″, also causes the rotation of the third rotatable element 23′, which—being coaxial and integral in rotation with a corresponding first rotatable element 21′—also causes the rotation of said first rotatable element 21′, thus moving the corresponding first track 3.

Conveniently, in a possible embodiment such as the one illustrated in the figures, the rotatable elements 21′, 21″ and the further rotatable elements 23′ and 23″ around which the first tracks 3 and the second tracks 4 are wrapped respectively are not directly motorized, but rather are driven in rotation by corresponding motion transmission means and organs.

Preferably, the motor means 25′, 25″ for moving the tracks 3 and 4 are positioned at and between the second tracks 4.

Advantageously, each first track 3 and/or each second track 4 can comprise tensioning rollers, not shown, of the corresponding track.

Advantageously, each first track 3 and/or each second track 4 can be covered laterally and/or above, at least in part, by a crankcase.

Preferably, at the support frame 22 which is inclined, a transverse casing 8 can be provided to contain and/or cover the respective motors 25′ and 25″, as well as the first transmission means 26. Conveniently, said transversal casing 8 it extends between the two second tracks 4 and is fixed and/or mounted on the support frame 22.

Conveniently, the support structure 2 includes a raised portion 30 which extends away from the main sliding plane 19. Preferably, the raised portion 30 is indeed raised with respect to the elongated sections 20 and with respect to the first tracks 3. Preferably, the raised portion 30 develops along (or parallel to) the Z direction and is substantially perpendicular to the first tracks 3. Preferably, the raised portion 30 is positioned internally between the first tracks 3. In a possible embodiment such as that illustrated in the drawings, said raised portion 30 includes two substantially L-shaped brackets which are facing each other and spaced apart.

The trolley 1 includes a structure, indicated overall with the reference 40, which is articulated to the support structure 2 and which is configured to support and move a pallet 50. In particular, the structure 40 includes two pallet-holder arms 43 which are configured to engage/fork a pallet 50 to be moved and, in particular, to be inserted into the side slots provided in a pallet 50.

Preferably, the two pallet-holder arms 43 comprise at least one element with longitudinal development and a “C”-shaped cross section facing downwards.

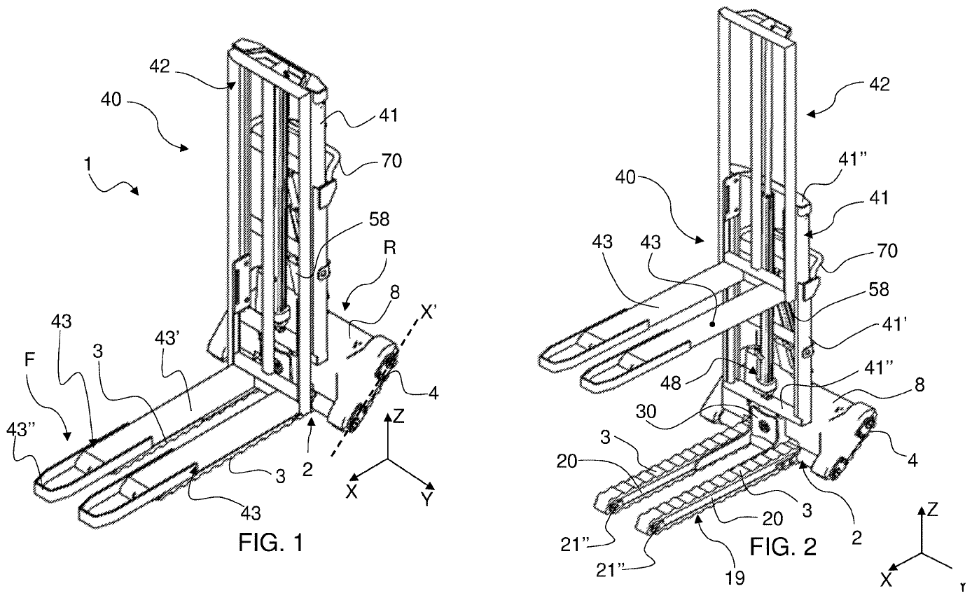

The trolley 1 is configured so that the upper base of the two pallet-holder arms 43 is always positioned above the upper section (i.e. the section which never rests on the surface) of the first tracks 3. Preferably, even in the minimum lifting condition of the pallet-holder arms 43 with respect to the first tracks 3 (see FIGS. 1, 4a, 4b), the distance of the upper base of the pallet-holder arms 43 with respect to the main sliding surface 19 of the trolley 1 (which is defined by the lower section of the first tracks 3 which is in contact with the surface), and therefore the distance of the upper base of the pallet holder arms 43 from the ground/soil is lower than the height of the slots of the pallet 50.

Conveniently, the two first tracks 3 are configured so as to have a height (i.e. a development along the Z direction) which is lower than the height of the slots of the pallet 50, to thus allow—during the forklift phase—their insertion within the height of the pallet itself.

Preferably, the two first tracks 3 are configured so as to have a height of less than 100 mm, more preferably less than 60-80 mm.

Preferably, in the picking/forking phase of a pallet 50, in which the two pallet-holder arms 43 are in the closest position with respect to the two first tracks 3, the height with respect to the ground/soil of said two arms—and in detail of the upper surface of said two arms—(preferably overlapping with respect to the first tracks 3) is less than 100 mm, more preferably less than 60-80 mm.

Preferably, for this purpose, the two pairs of rotatable elements 21′ and 21″ around which the first tracks 3 are wrapped can have a diameter of less than 100 mm, more preferably less than 60-80 mm, and even more preferably less than approximately 50 mm, for example they can have a diameter of approximately 47 mm.

Preferably, the first rotatable elements 21′ have a diameter substantially corresponding to that of the third rotatable elements 23′.

Preferably, the first tracks 3 and/or the second tracks 4 are suitably elastic. In particular, in order to allow the wrapping around rotatable elements 21′, 21″ and/or said further rotatable elements 23′, 23″ of said diameter, the tracks 3 and/or 4 are made of a rubber compound having suitable elasticity characteristics.

Conveniently, the trolley 1 is configured so that, when the pallet-holder arms 43 fork the pallet 50 resting on the ground/soil, the pallet-holder arms 43 and also the first tracks 3 (which are resting on the ground/soil) are located below the upper surface of the pallet 50 (i.e. below the surface of the pallet on which the load to be transported is intended to be placed) and also within the plan dimensions of the pallet itself. Advantageously, this allows the lateral bulk of the trolley to be reduced and, in particular, it also allows two pallets to be loaded side by side and close to each other.

In particular, the pallet support and movement structure 40—as a whole—is configured to fork a pallet 50, to move the pallet thus loaded so as to distance/bring it closer from/to the first tracks 3, and also to rotate the pallet thus mounted towards the front F and also, at a distinct moment, towards the rear R of trolley 1.

Preferably, the support structure 2 of the tracks 3 and 4 comprises:
two elongated sections 20 for the support of rotatable elements 21′, 21″ around which the two first tracks 3 are wrapped respectively,
a support frame 22, which is inclined with respect to the two elongated sections 20, which is configured to support further rotatable elements 23′, 23″ around which the two second tracks 4 are wrapped respectively;
a raised portion 30 with respect to the first tracks 3 at which the structure 40 for supporting and moving at least one pallet 50 is articulated.

The pallet support and movement structure 40 is articulated to the support structure 2 above the first tracks 3, thus advantageously allowing a greater angle of inclination of the structure 40 towards the front F and also towards the rear R of the trolley.

Preferably, the pallet support and movement structure 40 is articulated to the support structure 2 at the connection area between the first tracks 3 and the second tracks 4. More preferably, the pallet support and movement structure 40 is articulated at the raised portion 30, to thus avoid that—following the rotation of the pallet support and movement structure 40 towards the rear R of the trolley—the latter comes in contact with the inclined support frame 22 of the second tracks 4.

Preferably, in a possible embodiment, the structure 40 comprises:
a first frame 41 which is articulated to the support structure 2 and, more preferably, is articulated to the raised portion 30 of the support structure 2,
a second frame 42 which is mounted on said first frame 41 so as to be able to slide with respect to the latter,
said two pallet-holder arms 43 which are mounted on the second frame 42.

In particular, the two pallet-holder arms 43 extend along a direction X (or in any case parallel to the direction X), they are parallel to each other and are mutually spaced apart along a direction Y (or in any case parallel to the direction Y).

In more detail, the two pallet-holder arms 43 define the prongs of a fork for picking and lifting a pallet 50.

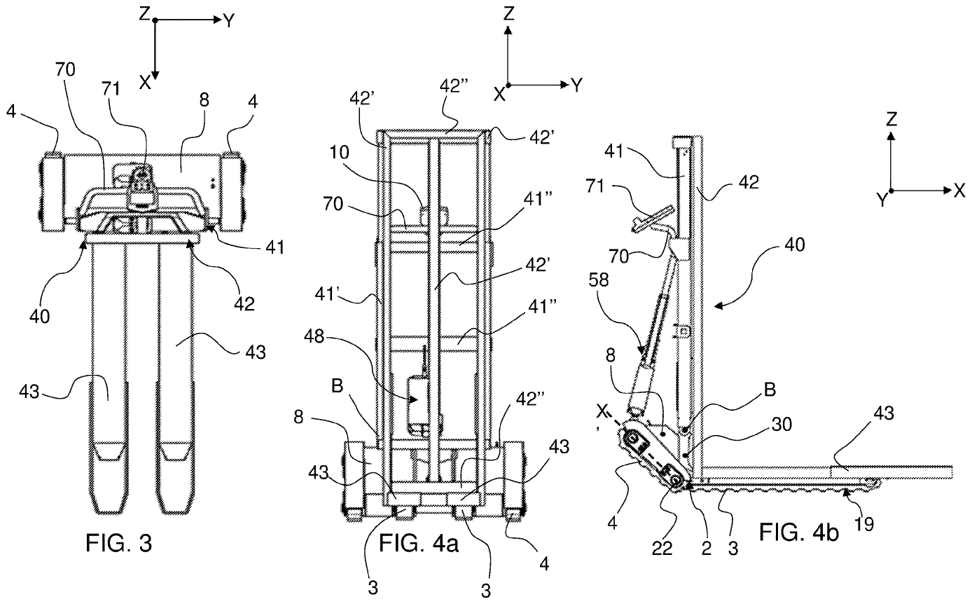

Preferably, the two pallet-holder arms 43 are configured so as to overlap vertically respectively with the two first tracks 3, more preferably so that—in plan view—the two first tracks 3 are covered by the respective two pallet-holder arms 43 (see FIG. 3). In other words, in a condition (see FIG. 1) in which the first frame 41 is arranged perpendicularly with respect to the first tracks 3 (i.e. it is not inclined either towards the front F or towards the rear R of the trolley) and in which the second frame 42 is in a lowered position (i.e. in which the sliding of the second frame 42 with respect to the first frame 41 is minimal or non-existent), the two pallet-holder arms 43 mounted on the second frame 42 are in a close position (or substantially in contact) with the respective first two tracks 3.

Conveniently, in a possible embodiment not shown here, the two pallet-holder arms 43 are arranged laterally with respect to the first tracks 3.

Conveniently, the two pallet-holder arms 43 can protrude in length (i.e. along a direction parallel to the X direction) beyond the first tracks 3.

Preferably, the two pallet-holder arms 43 have a development in length (i.e. along a direction parallel to the X direction) and in width (i.e. along a direction parallel to the Y direction) which is greater than that of the first tracks 3.

The first frame 41 can have a substantially rectangular shape with two first uprights 41′ connected to each other by two or more first crosspieces 41″. Preferably, the first frame 41 is articulated to the raised portion 30 at a first crosspiece 41″ provided at its lower end.

The second frame 42 can have a substantially rectangular shape and, for example, two or three second uprights 42′ can be provided, connected to each other at the bottom and top by two respective second crosspieces 42″. Preferably, the pallet-holder arms 43 protrude perpendicularly from a second crosspiece 42″ provided at the lower end of said second frame 42.

Conveniently, corresponding to the two first uprights 41′ of the first frame 41 there are respective guides along which corresponding second uprights 42′ of the second frame 42 slide.

The trolley 1 also includes at least a first actuator 48 which is mounted on the pallet support and movement structure 40 and which is configured to move the pallet-holder arms 43 so as to distance/bring them closer from/to the first tracks 3, in particular to operate the lifting/lowering of the pallet-holder arms 43 with respect to the first tracks 3. Conveniently, the second frame 42 is mounted on said first frame 41 so that said first actuator 48 causes the movement/sliding of said second frame 42 with respect to said first frame 41. In particular, the first actuator 48 is configured to activate the movement/sliding of the second frame 42 with respect to the first frame 41, thus causing the pallet-holder arms 43 to move away/closer with respect to the first tracks 3, and therefore the lifting/lowering of the pallet 50 mounted on the pallet-holder arms 43. Conveniently, when the first frame 41 is arranged substantially perpendicular to the first tracks 3, the first actuator 48 causes a lifting/lowering movement of the pallet-holder arms 43 along a direction parallel to the Z direction and so that the pallet-holder arms 43 are arranged parallel to the first tracks 3 for their entire longitudinal development.

Preferably, the first actuator 48 is of the linear type. Preferably, the first actuator 48 is of the electric type. Conveniently, in some possible embodiments, the first actuator 48 can be of the hydraulic or pneumatic type.

Conveniently, in a condition in which the first frame 41 is arranged perpendicularly with respect to the first tracks 3 resting on the ground, the first actuator 48—which is a linear actuator—is arranged substantially perpendicular with respect to the ground and causes a lifting/lowering which substantially is perpendicular to the ground of the second frame 42 with the pallet-holder arms 43, which thus remain substantially parallel to the ground for the entire lifting/lowering stroke of the second frame 42. Advantageously, this allows to lift, via the pallet-holder arms 43, the pallet 50 (with or without load) in order to load/unload it for example into/from a van or truck.

Preferably, the first actuator 48 is arranged centrally between the two first tracks 3, in particular along a direction parallel to Y.

Conveniently, the first actuator 48 includes a fixed part (cylinder) which is mounted on the first frame 41 and a movable part, which is movable with respect to the fixed part, which is associated with the second frame 42, or vice versa. Preferably, the first actuator 48 is positioned centrally between the two first outermost uprights 41′ of the first frame 41 and between the two second outermost uprights 42′ of the second frame 42. Preferably, the first actuator 48 faces a second central upright 42′ with which the second frame 42 can be equipped.

Preferably, the mobile part of the first actuator 48 is associated, at one of its upper ends, with the upper crosspiece 42″ of the second frame 42.

Preferably, the first actuator 48 is completely housed within the dimensions of said structure 40 for supporting and moving at least one pallet 50. More preferably, the first actuator 48 can be housed within the dimensions, at least along directions parallel to X and Y, of the first frame 41.

Conveniently, the first actuator 48 is associated with the second frame 42 at an area of said frame which is spaced apart, preferably opposite, from the area from which the pallet-holder arms 43 extend.

The trolley 1 also includes at least a second actuator 58 which is operatively associated with said support structure 2 and with said pallet support and movement structure 40 and which is configured to rotate the pallet-holder arms 43 towards the front F of the trolley 1 and also, at a distinct moment, towards the rear R of the trolley 1. Conveniently, the second actuator 58 causes the angular displacement of the pallet support and movement structure 40 towards the front F and also, at a distinct moment, towards the rear R of the trolley 1. Preferably, the second actuator 58 is configured to operate the rotation of the first frame 41—and therefore also of the second frame 42 with the pallet-holder arms 43—towards the front F and also, at a distinct moment, towards the rear R of the carriage 1. Preferably, the second actuator 58 activates the rotation of the first frame 41 around an articulation axis B (which is parallel to the Y direction) of said first frame 41 to the raised portion 30 of the support structure 2.

Preferably, said at least one second actuator 58 is of the linear type. Preferably, the second actuator 58 is of the electric type. Conveniently, in some possible embodiments, the second actuator 58 can be of the hydraulic or pneumatic type.

Preferably, said at least one second actuator 58 is of the linear type and is arranged at an angle both with respect to the first tracks 3 and with respect to the first actuator 48.

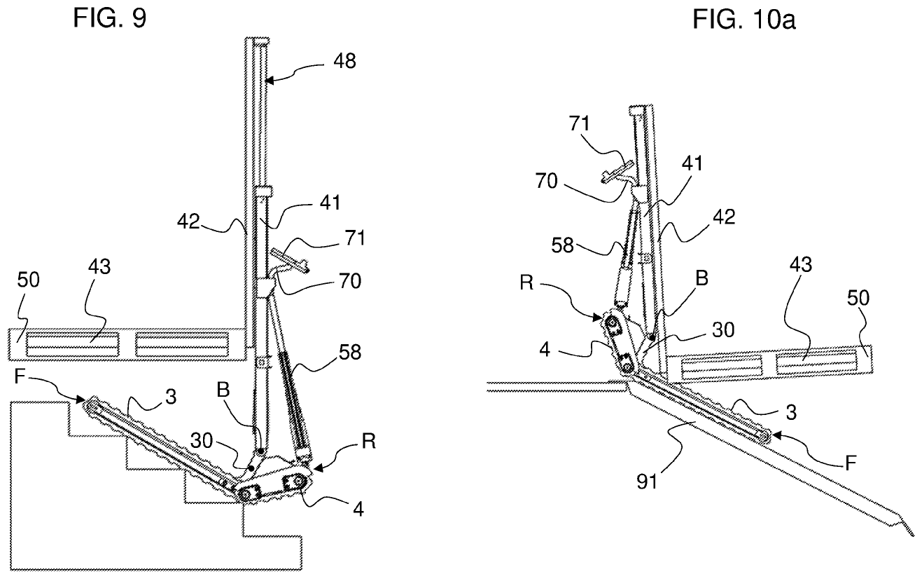

Advantageously, the second linear actuator 58 allows both the inclination of the structure 40 (and therefore of the load) towards the second tracks 4, to thus move backwards on stairs and inclined planes, and the inclination of the structure 40 (and therefore of the load) towards the tip ends of the first tracks 3, to thus allow to travel along stairs or inclined planes with a direction of advancement in which the tip ends of the first tracks 3 rise before the second tracks 4 (see FIGS. 9 and 11). In particular, climbing stairs or inclined planes with a direction of advancement in which the tip ends of the first tracks 3 rise before the second tracks 4 is possible by means of said at least one second linear actuator 58 which appropriately regulates the rotation of the pallet-holder arms 43 and also by means of the first linear actuator 48 which appropriately lifts/distances the pallet-holder arms 43 from the first tracks 3, thus appropriately lifting the load. Preferably, in this case, the electronic command and control unit of the trolley 1 manages the coordinated action of said at least one second actuator 58 and of the first linear actuator 48.

Preferably, the second actuator 58 comprises:
a fixed part which is associated—preferably at one of its ends—with the support structure 2 and, in particular, with the support frame 22 of said support structure 2, and
a mobile part (stem), which is in fact mobile with respect to the fixed part, and which is associated—preferably at one of its ends—with the first frame 41, for example at a first crosspiece 41″ of the first frame 41.

Conveniently, it is understood that the articulation of the fixed part of the second actuator 58 to the support structure 2 and the articulation of the mobile part of the second actuator 58 to the first frame 41 could also be reversed.

Preferably, the second actuator 58 is arranged inclined between the support frame 22 and the first frame 41.

Preferably, the second actuator 58 is positioned centrally between the two first outermost uprights 41′ of the first frame 41 at the rear R of the trolley 1. Preferably, the mobile part of the second actuator 58 is articulated, at one of its lower ends, to the support frame 22 in a central area which is interposed between the two motors 25′ and 25″.

Advantageously, the trolley 1 is equipped with grip and/or grip means 70 which are configured to be gripped by a user.

Preferably, the grip means 70 are mounted on the first frame 41. Preferably, the grip means 70 comprise at least one handle.

Advantageously, a user interface 71 for command and/or control of the trolley can be mounted on the grip means 70 or on another part of the first frame 41, such as for example a push-button panel, with buttons and/or levers, and/or a touch-screen. Alternatively, the command and/or control user interface 71 of the trolley 1 can be positioned on a suitable remote control, or other remote-control system, which thus allows its use by an operator even if he is not in contact/near the trolley itself.

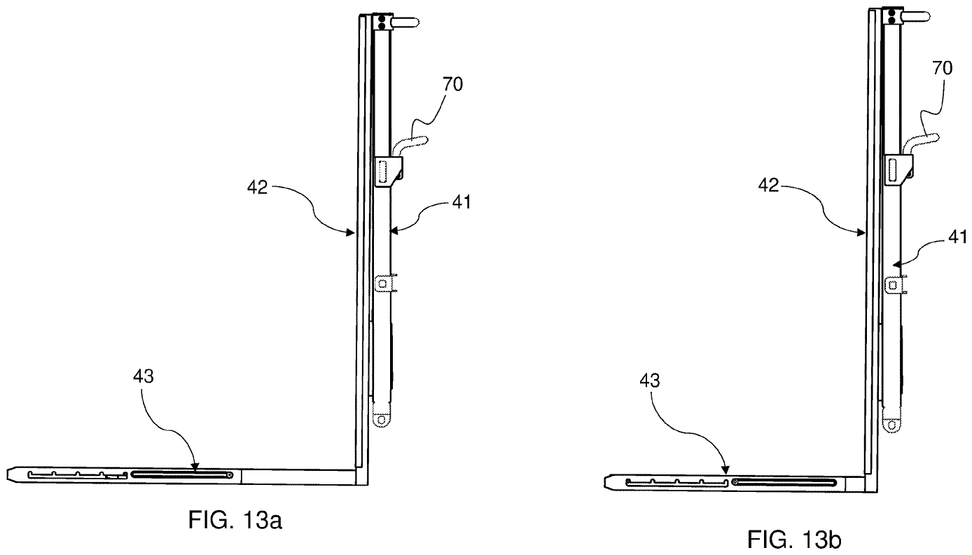

Advantageously, each of the two pallet-holder arms 43 can be extendable, to thus assume at least an elongated condition (see FIG. 13a) and a shortened condition (see FIG. 13b), and preferably also one or more intermediate conditions. In particular, each of the two arms can include at least two longitudinal members configured so that one can slide with respect to the other and also so as to lock stably with respect to the other in a plurality of predefined positions. For example, for this purpose, at least one of the two longitudinal members can be provided with a pin which engages within corresponding notches obtained on an elongated slot obtained on the other longitudinal member. Preferably, each pallet-holder arm 43 includes a fixed section 43′ and a mobile section 43″ which is mounted externally on the sides of the fixed section (in particular around the latter) so as to be able to slide with respect to said fixed section. Advantageously, this allows to have extendable pallet-holder arms 43 without increasing their overall height, thus allowing the forklifting of pallets of standard dimensions (for example remaining below the 100 mm required for pallets according to the European “EUR” standard).

Conveniently, the trolley 1 includes an electronic command and control unit (not shown). Preferably, the electronic control unit commands and controls the two electric motors 25′, 25″ for moving the tracks 3, 4, the first actuator 48 to activate the lifting/lowering of the pallet-holder arms 43, and the second actuator 58 to activate the rotation of the pallet-holder arms 43 towards the front F and also, at a distinct moment, towards the rear R of the trolley.

Conveniently, the electronic command and control unit is electronically connected to said two electric motors 25′, 25″. Preferably, the control unit is electronically connected with the first actuator 48 and with the second actuator 58, to thus send corresponding control signals to them.

Preferably, said first actuator 48 and/or said second actuator 58 can also be provided with corresponding encoders (or equivalent devices) to thus provide the electronic command and control unit with corresponding signals representative of the position of the respective frames moved by them.

Preferably, the electronic command and control unit can be configured to send to the two electric actuators 48 and 58 corresponding control signals processed on the basis of the position signals provided by the respective encoders associated with said two actuators. More preferably, the electronic command and control unit is configured to receive and use the position signals provided by the respective encoders associated with said two actuators 48 and 58 so that they operate in a controlled and coordinated manner during the ascent or descent of the staircase 90 or ramp 91 in order to maintain the stability of the pallet 50 carried by the pallet-holder arms 43.

Preferably, said two electric motors 25′, 25″ can also be provided with corresponding encoders (or equivalent devices) to thus provide the electronic command and control unit with corresponding signals representative of the position of the respective tracks driven by them.

Conveniently, the trolley 1 also includes at least one power supply unit (battery)—not shown—for the electrical power supply of said two electric motors 25′, 25″, of the first actuator 48 and of the second actuator 58, and/or of any additional electrically powered components with which the trolley may be equipped.

Advantageously, during the ascent and descent phase of the staircase 90 or a ramp 91, the second actuator 58 for the angular movement of the structure 40 is configured to tilt the first frame 41 towards the front F and also, at a distinct moment, towards the rear R of the trolley with respect to the first tracks 3, which rest and advance on the steps of the staircase 90 or on the surface of the ramp 91.

Advantageously, the second actuator 58 is controlled—manually by the operator or automatically—so as to vary the inclination of the first frame 41, and therefore of the pallet-holder arms 43 which fork the pallet 50, with respect to the support structure 2 and to the first tracks 3 (and this is based on the slope of the staircase/ramp and also on the characteristics of the pallet and/or the load placed on the pallet) so as to compensate for the center of gravity of the entire trolley while it is transporting the pallet with/without load.

Advantageously, during the ascent or descent of a staircase or ramp, the second actuator 58 is controlled—manually by the operator or automatically—in order to vary the inclination of the first frame 41 with respect to the support structure 2 and the first tracks 3 so that said first frame 41 is substantially always aligned with the vertical direction of the gravitational force.

Conveniently, the second actuator 58 is configured to cause the angular displacement of the structure 40 around an axis B which is substantially horizontal and, preferably, transversal to the two first tracks 3 and the two second tracks 4. In particular, the articulation axis B is defined at the raised portion 30 of the support structure 2 and is aligned parallel to the Y direction. Conveniently, the articulation axis B is also parallel to the axes A′, A″, A′″ and A″″ for rotation of the various rotatable elements, as described above, which are involved in the movement of the two first tracks 3 and the two second tracks 4.

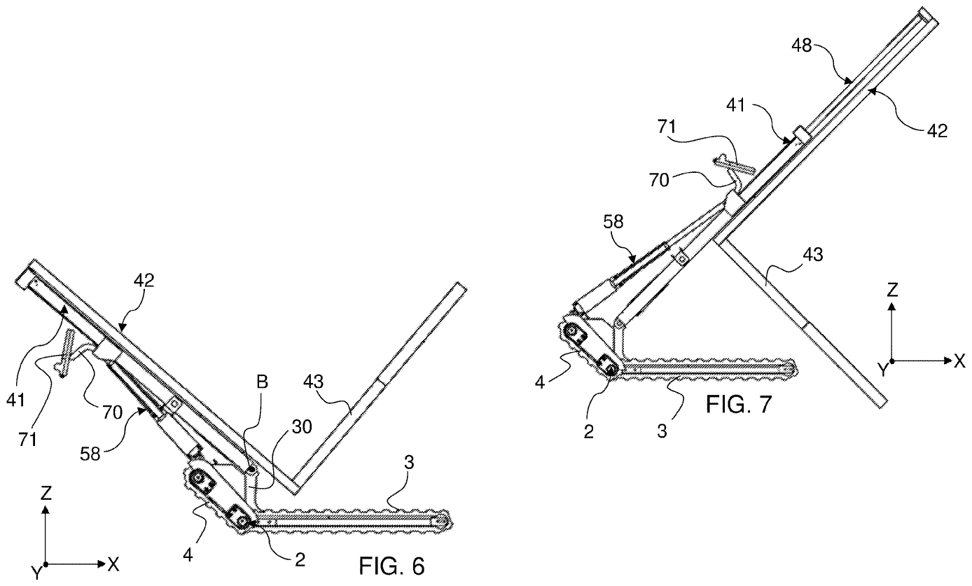

Advantageously, the second actuator 58 can be configured to cause the angular displacement of the structure 40 so as to reach a condition in which the first frame 41 is inclined towards the rear R of the trolley, thus bringing the pallet-holder arms 43 into a position in which they are inclined upwards (see FIG. 6). Advantageously, the second actuator 58 can be configured to cause the angular displacement of the structure 40 so as to reach a condition in which the first frame 41 is inclined towards the front F of the trolley, thus bringing the pallet-holder arms 43 into an arrangement in which are inclined downwards (see FIG. 7). Conveniently, in this case, the second frame 42 which supports the pallet-holder arms 43 can also be raised along the first frame 41 through the operation of the first actuator 48.

Preferably, in the trolley 1, the pallet support and movement structure 40 is articulated to the support structure 2 substantially at the connection area between the first tracks 3 and the second tracks 4, the first actuator 48 is positioned inside the overall dimensions of the structure 40, while the second actuator 58 is positioned rearward with respect to the structure 40, articulating with one of its ends to the inclined support frame 22 of the second tracks 4.

Conveniently, the second tracks 4 mounted on the support frame 22 have an inclination such that, when the first tracks 3 rest entirely on the landing or ground floor, and are located near and in front of a first step of the staircase 90 to be climbed, the second tracks 4 come into contact with said first step, and in particular with the protruding part of the tread of said step. In other words, the second tracks 4 are configured so that the height of their free end (i.e. the distance with respect to the extension of the lower section of the first tracks 3) is equal to or greater than the rise of the traditional steps, and—preferably—for example, it is equal to or less than approximately 21 cm. Advantageously, the presence of the second tracks 4 which are inclined with respect to the first tracks 3 makes it easier to grip the first step of the stairs to be climbed.

Advantageously, the trolley 1 can assume at least one operating condition in which the first frame 41 is substantially arranged vertically and perpendicularly to the first tracks 3, and this condition can be used to move the trolley on substantially horizontal flat ground and/or in proximity to the beginning of the ascent of a staircase 90 and/or near the end of the descent of a staircase 90, as described in more detail below.

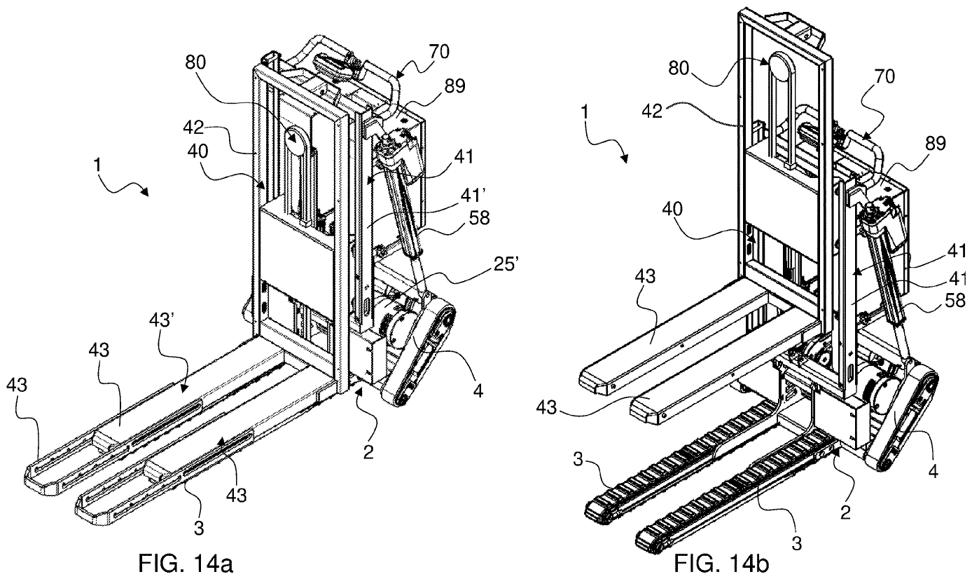

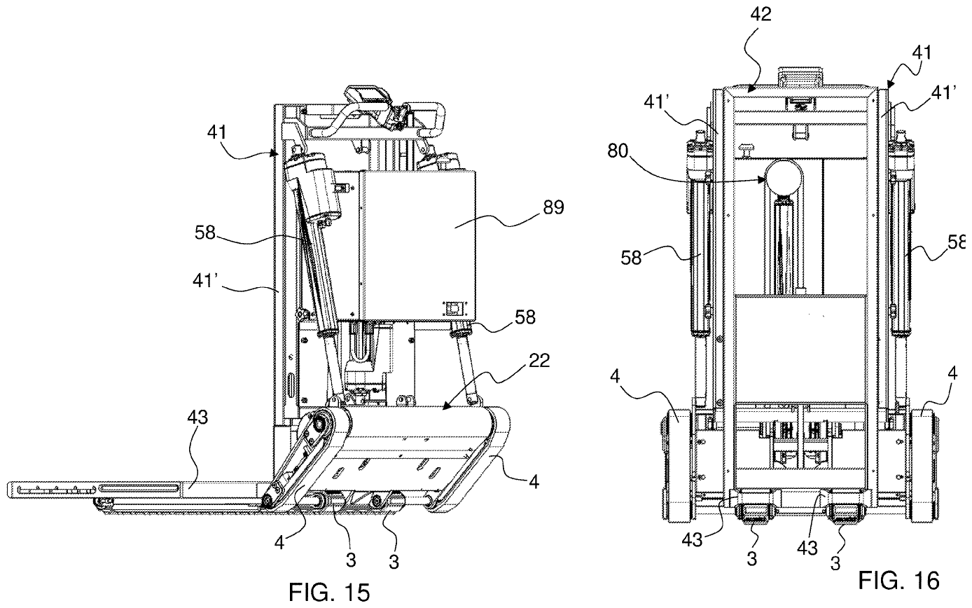

Preferably, in a possible embodiment (see FIGS. 14a, 14b, 15 and 16), two second actuators 58 are provided, both operationally associated with said support structure 2 and with said pallet support and movement structure 40 to rotate the pallet-holder arms 43 towards the front F of the trolley 1 and also, at a distinct moment, towards the rear R of the trolley 1. In particular, each of the two second actuators 58 is positioned at a corresponding side of the pallet support and movement structure 40. Preferably, the two second actuators 58 are arranged inclined between the support frame 22 and the first frame 41. Preferably, the second actuators 58 are positioned laterally and, in particular, each of these has an end which is articulated to a respective first upright 41′ of the first frame 41 at the rear R of the trolley 1. Preferably, the lower end of each of the two second actuators 58 is articulated to the support frame 22 at the second tracks 4. More preferably, each of the two second actuators 58 is positioned between a corresponding first upright 41′ of the first frame 41 and a corresponding second track 4.

Advantageously, the use of two second actuators 58 positioned on the sides of the first frame 41 allows the frame itself, and therefore the structure 40, to be connected in a more mechanically stable way to the underlying support structure 2.

Preferably, a single container can be provided for the power unit (battery) which is positioned between the two second actuators 58. In particular, the container housing the power unit can have a substantially box-like shape and can be fixed centrally to the first frame 41 between the two second actuators 58 which are thus positioned externally and laterally with respect to said container.

Advantageously, the use of two second actuators 58 positioned on the sides of the first frame 41 allows to have sufficient space centrally for the positioning of a single container of standard shape (for example substantially box-shaped) for housing the power supply unit, thus avoiding using multiple containers and/or particular shapes of the container(s).

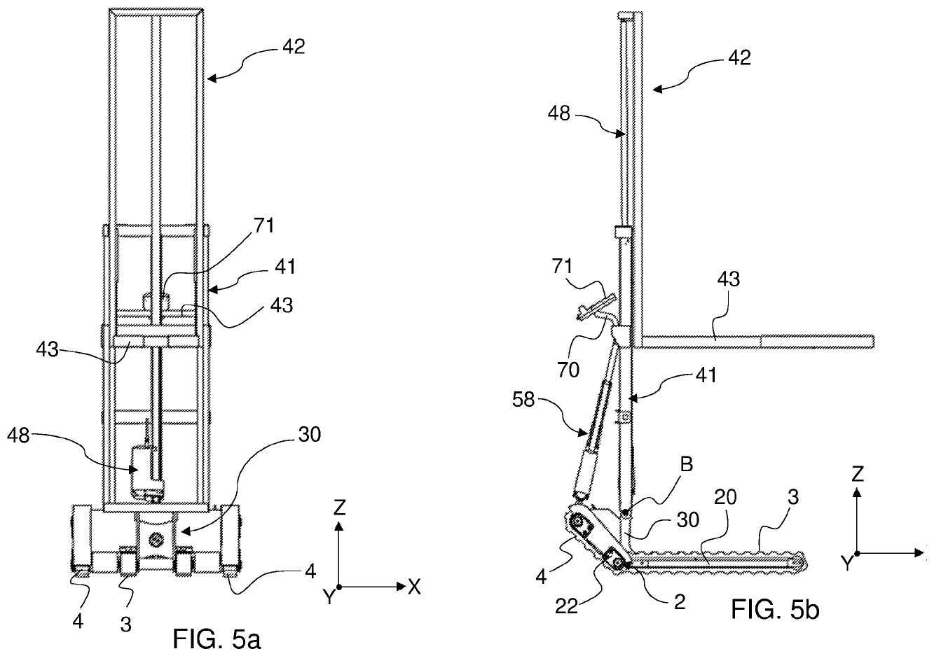

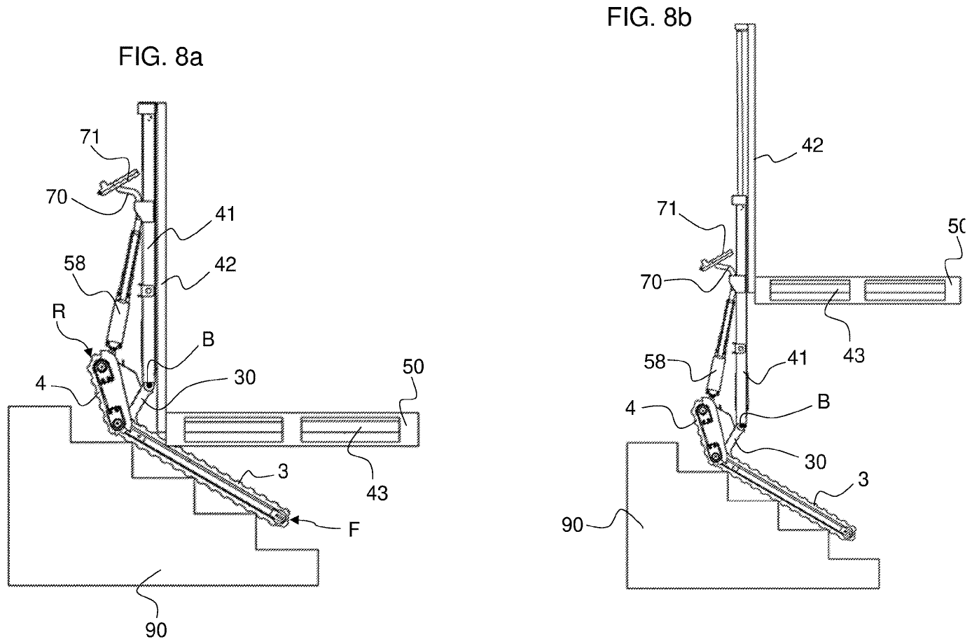

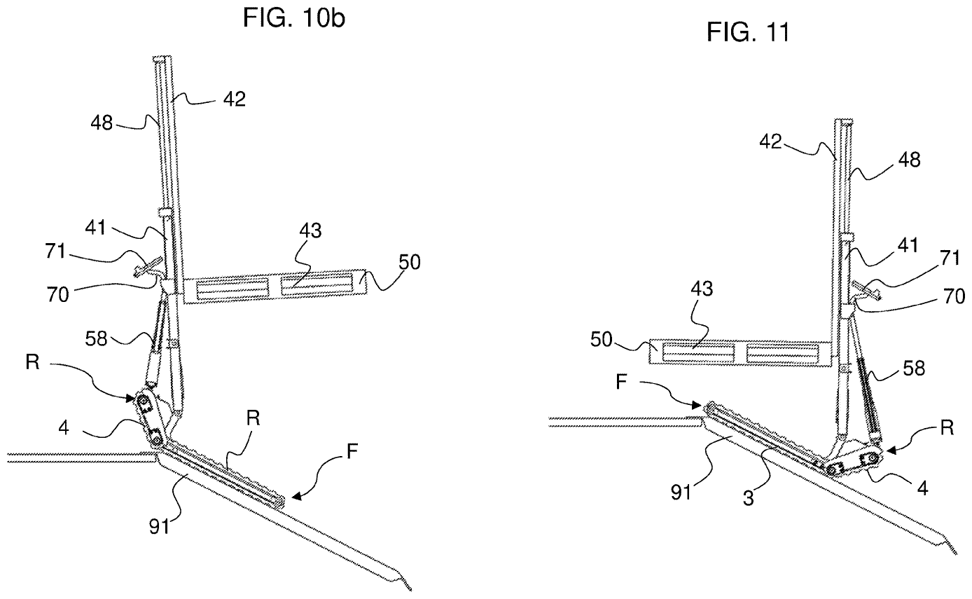

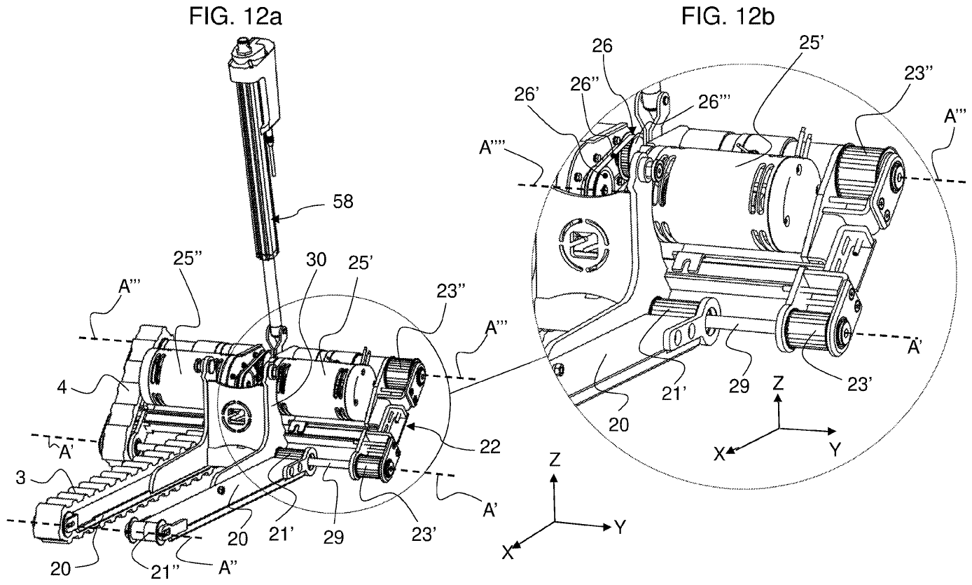

Preferably, in a possible embodiment (see FIGS. 1-13), the first actuator 48 is mounted on the first frame 41 and is connected directly to the second frame 42.

Preferably, in another possible embodiment (see FIGS. 14a, 14b, 15 and 16), the first actuator 48 is mounted on the first frame 41 and is connected to the second frame 42 by means of a return mechanism 80, more preferably a pulley. Advantageously, this allows to increase, with the same actuator, the speed and lifting range of the second frame 42 on which the pallet-holder arms 43 are mounted and also allows to reduce the overall height of the structure 40, thus allowing for example the possibility of loading the trolley in vans with a lower roof.

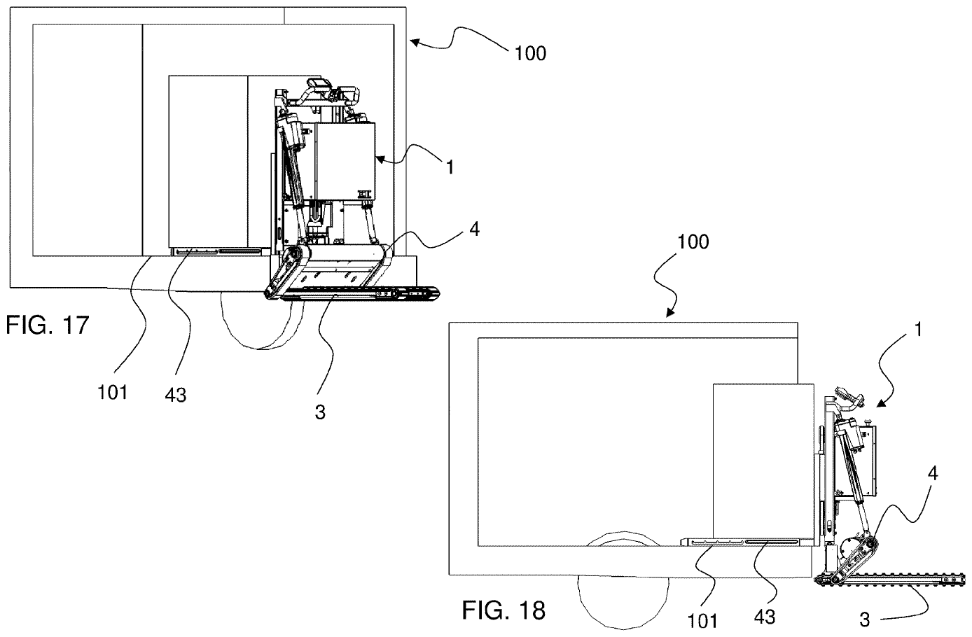

In a further embodiment illustrated in FIGS. 17 and 18, the two first tracks 3 can translate rearwardly (i.e. towards the rear R) with respect to the second tracks 4 to thus bring them to the rear area of the trolley itself and thus advantageously allow its self-loading onto a van. In more detail, the first tracks 3 slide along their direction of longitudinal development. Advantageously, in this case, after the pallet-holder arms 43 have rested on the loading surface of the van, the first tracks 3 are moved towards the rear R of the trolley and the first actuator 48 is then activated to thus bring the first tracks 3 at the level of the pallet-holder arms 43, thus lifting the trolley from the ground.

From what has been said it is clear that the trolley according to the present invention is particularly advantageous as it is particularly compact and also allows a pallet (with or without load) to be transported in a safe and agile way downhill from or up a ramp or staircase of any size or shape, whether helical or straight.

Furthermore, advantageously, the trolley according to the invention is particularly flexible as it can be used to climb a ramp or staircase in both directions of travel, both with the operator positioned upstream (see 8a, 8b, 10a, 10b) and with the operator positioned downstream (see FIGS. 9 and 11).

The trolley described above is susceptible to numerous modifications and variations within the scope of protection defined by the content of the claims.

The present invention has been illustrated and described in some of its preferred embodiments, but it is understood that executive variations may be made to them in practice, without however departing from the scope of protection of the present patent for industrial invention.

1. Trolley for lifting and transporting at least one pallet on a staircase and/or ramp the trolley comprising:
a support structure which is configured to support two first tracks and two second tracks, wherein
said first two tracks, are parallel to and spaced apart from each other, and
said two second tracks are parallel to and spaced apart from each other, said second tracks being positioned at the front or the rear of the trolley, being inclined with respect to the first tracks and being arranged externally with respect to said first tracks,
motor means for moving the two first tracks and the two second tracks,
a structure which is articulated to the support structure and which is configured to support and move at least one pallet, said structure comprising two pallet-holder arms which are configured to engage/fork a pallet to be transported and/or lifted,
at least one first actuator which is mounted on said structure for supporting and moving at least one pallet and which is configured to move the pallet-holder arms so as to distance/bring them closer from/to the first tracks,
at least one second actuator which is operatively associated with said support structure and with said structure for supporting and moving at least one pallet and which is configured to rotate the pallet-holder arms towards the front of the trolley and also, at a distinct moment, towards the rear of the trolley,
and wherein:
the structure for supporting and moving at least one pallet is articulated to the support structure above the first tracks,
and wherein said structure for supporting and moving at least one pallet comprises:
a first frame which is articulated to the support structure,
a second frame which is mounted on said first frame so that said at least one first actuator causes the movement/sliding of said second frame with respect to said first frame,
said two pallet-holder arms which are mounted on the second frame.

2. The trolley according to claim 1, wherein when the pallet-holder arms are in a position suitable for forking a pallet resting on the ground/soil, the pallet-holder arms and also the first tracks which rest on the ground are located below an upper surface of the pallet and also within the plan dimensions of the pallet.

3. The trolley according to claim 1, wherein said motor means include:
a first electric motor to implement the movement of a first track and of a second track positioned on a first side of the trolley,
a second electric motor to implement the movement of the other first track and of the other second track positioned on the other side of the trolley.

4. The trolley according to claim 1, wherein said at least one first actuator is of the electric type, and said at least one second actuator is of the electric type.

5. The trolley according to claim 1, further comprising:
first motion transmission which are configured to transfer the output motion of said motor means in order to cause movement of the respective second tracks,
said second tracks also act as a motion transmission member in order to cause movement of the respective first tracks.

6. The trolley according to claim 1, wherein said support structure includes:
two elongated sections for supporting rotatable elements around which the first two tracks are wrapped respectively,
a support frame for supporting further rotatable elements around which the two second tracks are wrapped respectively, said support frame being inclined with respect to said two elongated sections,
a raised portion with respect to the first tracks at which the structure for supporting and moving at least one pallet is articulated.

7. The trolley according to claim 1, wherein said at least one second actuator has one end articulated to the first frame while the other end is articulated to said support frame which is inclined.

8. The trolley according to claim 1, wherein said two electric motors are mounted on said support frame of the second tracks.

9. The trolley according to claim 1, wherein said at least one second actuator is articulated to said support frame of the second tracks at an area of said support frame which is placed between said two electric motors.

10. The trolley according to claim 1, wherein said raised portion is defined at the connection area between the first tracks and the second tracks.

11. The trolley according to claim 1, wherein said two pallet-holder arms are configured so as to overlap vertically respectively to the two first tracks, so that, in plan view, the two first tracks are covered by the respective two pallet-holder arms.

12. The trolley according to claim 1, wherein said at least one first actuator is completely housed within the dimensions of said structure for supporting and moving at least one pallet.

13. The trolley according to claim 1, wherein:
the structure for supporting and moving at least one pallet is articulated to the support structure at the connection area between the first tracks and the second tracks,
said at least one first actuator is completely housed within the dimensions of said structure for supporting and moving at least one pallet,
said at least one second actuator is positioned rearward with respect to the structure, articulating with one of its ends to the inclined support frame of the second tracks.

14. The trolley according claim 1, wherein each of the two pallet-holder arms is extendable, to thereby assume at least an elongated condition and a shortened condition, and also one or more intermediate conditions.

15. The trolley according to claim 1, wherein said at least one first actuator is of the linear type, and said at least one second actuator is of the linear type.

16. The trolley according to claim 1, wherein said at least one second actuators are two second actuators, each of which is positioned at one side of the structure for supporting and moving at least one pallet.

17. The trolley according to claim 1, wherein the at least one first actuator is mounted on the first frame and is connected to the second frame by a return mechanism.

18. The trolley according to claim 1, wherein:
said two first tracks are placed side by side along a direction parallel to a Y direction and develop longitudinally parallel to an X direction corresponding to the direction of advancement of the trolley,
when the first frame is arranged substantially perpendicular to the first tracks, said at least one first actuator causes a lifting/lowering movement of the pallet-holder arms along a direction parallel to a Z direction, which is perpendicular to the X and Y directions, and so that the pallet-holder arms are arranged parallel to the first tracks for their entire longitudinal development.

19. The trolley according to claim 1, wherein the at least one first actuator is arranged centrally between the two first tracks.

20. The trolley according to one or more of the claim 1, wherein, when the two pallet-holder arms are in the closest position with respect to the two first tracks, the height, with respect to the ground/soil, of said two arms is less than 100 mm.
